(19) United States
(12) Patent Application Publication
(10) Pub. No.: US 2013/0335594 A1
(43) Pub. Date: Dec. 19, 2013

(54) ENHANCING CAPTURED DATA

(71) Applicants: Hrvoje Benko, Seattle, WA (US); Paul Henry Dietz, Redmond, WA (US); Stephen G. Latta, Seattle, WA (US); Kevin Geisner, Mercer Island, WA (US); Steven Nabil Bathiche, Kirkland, WA (US)

(72) Inventors: Hrvoje Benko, Seattle, WA (US); Paul Henry Dietz, Redmond, WA (US); Stephen G. Latta, Seattle, WA (US); Kevin Geisner, Mercer Island, WA (US); Steven Nabil Bathiche, Kirkland, WA (US)

(73) Assignee: MICROSOFT CORPORATION, Redmond, WA (US)

(21) Appl. No.: 13/526,033

(22) Filed: Jun. 18, 2012

(51) Int. Cl. H04N 5/225

(52) U.S. Cl. 348/231.4; 348/231.3; 348/E05.024

(57) ABSTRACT

Captured data is obtained, including various types of captured or recorded data (e.g., image data, audio data, video data, etc.) and/or metadata describing various aspects of the capture device and/or the manner in which the data is captured. One or more elements of the captured data that can be replaced by one or more substitute elements are determined, the replaceable elements are removed from the captured data, and links to the substitute elements are associated with the captured data. Links to additional elements to enhance the captured data are also associated with the captured data. Enhanced content can subsequently be constructed based on the captured data as well as the links to the substitute elements and additional elements.

### BACKGROUND

Digital cameras today can be found in numerous different types of devices, including dedicated digital cameras, cell phones, computers, game consoles, and so forth. This widespread availability of digital cameras allows users to take large numbers of digital photos, but problems still remain. One such problem is that current digital cameras are typically simple image capture devices with basic functionality. This can be limiting for users, as the users are able to capture only digital photos that are snapshots in time of a particular scene.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, captured data regarding an environment is obtained. One or more additional elements are determined, based at least in part on the captured data, and links to the one or more additional elements are added as associated with the captured data. Construction of enhanced content using the one or more additional elements and at least part of the captured data is enabled.

In accordance with one or more aspects, a determination is made if a photographic element of a photograph is replaceable including identifying the replaceable photographic element and one or more substitute photographic elements. The replaceable photographic element is removed from the photograph, and one or more links to the one or more substitute photographic elements are added, generating a compressed photograph. A link to an additional element associated with the replaceable photographic element or the substitute photographic element is also added. Construction of an enhanced photograph is enabled using the compressed photograph and links to the one or more substitute photographic elements and the additional element.

### BRIEF DESCRIPTION OF THE DRAWINGS

The same numbers are used throughout the drawings to reference like features.

FIG. 1 illustrates an example system implementing the enhancing captured data in accordance with one or more embodiments.

FIG. 2 illustrates an example data enhancement system in accordance with one or more embodiments.

FIG. 3 is a flowchart illustrating an example process for enhancing captured data in accordance with one or more embodiments.

FIG. 4 is a flowchart illustrating another example process for enhancing captured data in accordance with one or more embodiments.

FIG. 5 illustrates an example computing device that can be configured to implement the enhancing captured data in accordance with one or more embodiments.

### DETAILED DESCRIPTION

Enhancing captured data is discussed herein. Captured data is obtained, and can include various types of recorded data (e.g., image data, audio data, video data, etc.) and/or metadata describing various aspects of the capture device and/or the manner in which the data is recorded. One or more elements of the recorded data that can be replaced by one or more substitute elements are determined. The replaceable elements are removed from the recorded data and links to the substitute elements are associated with the captured data. Links to additional elements to enhance the captured data are also associated with the captured data. Enhanced content can subsequently be constructed based on the recorded data as well as the links to the substitute elements and additional elements.

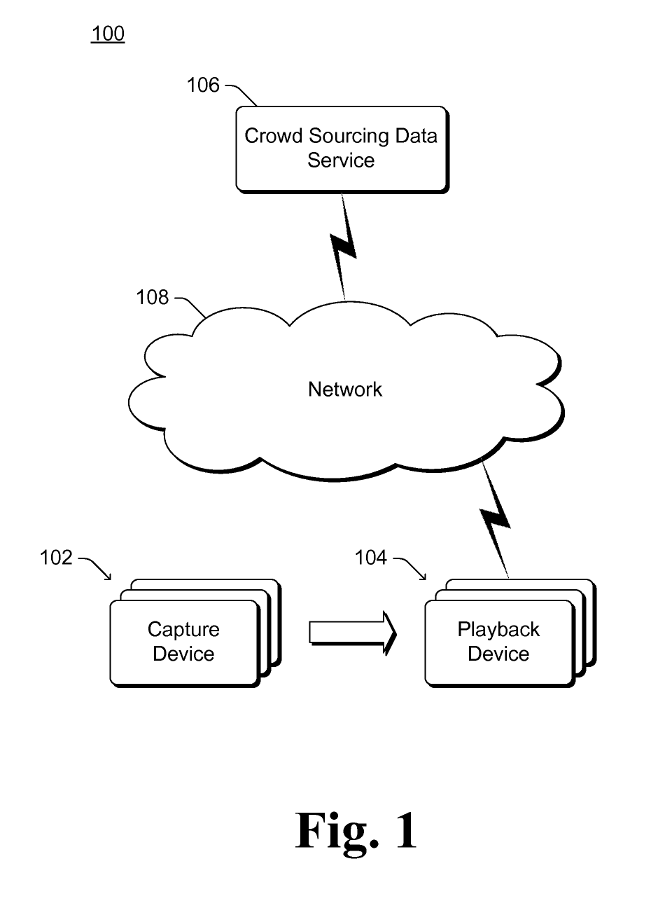

FIG. 1 illustrates an example system 100 implementing the enhancing captured data in accordance with one or more embodiments. System 100 includes one or more capture devices 102 that capture and provide data to one or more playback devices 104. Playback devices 104 communicate with a crowd sourcing data service 106 via a network 108. Network 108 can be a variety of different networks, including the Internet, a local area network (LAN), a public telephone network, an intranet, other public and/or proprietary networks, combinations thereof, and so forth. One or more capture devices 102 can also optionally communicate with crowd sourcing data service 106 and/or one or more playback devices 104 via network 108. Although illustrated as separate devices, it should be noted that a particular device can be both a capture device 102 and a playback device 104.

A capture device 102 captures data regarding a particular environment, also referred to as the environment associated with the captured data. The environment regarding or for which data is captured refers to the surroundings of capture device 102 when the data is captured. The environment can be, for example, inside a building, outside, at a concert, at a sporting event, at a party, and so forth. Each capture device 102 can be any of a variety of different types of devices capable of capturing data regarding an environment, such as a camera or camcorder, a tablet or notepad computer, a cellular or other wireless phone, a game console, an automotive computer, a dedicated data capture device (providing little if any additional functionality other that capturing data), and so forth. Different ones of capture devices 102 can be the same or different types of devices.

Capturing data refers to recording data and/or metadata regarding the environment. Recording data regarding the environment refers to recording or sensing characteristics of the environment itself. Any one or more of various types of data regarding the environment can be recorded, such as still image data, video data, audio data, combinations thereof, and so forth. For example, a capture device 102 can record a still image (e.g., photograph) of a particular environment, audio sensed in the particular environment, and so forth.

Recording metadata regarding the environment refers to recording metadata describing various aspects of the capture device 102, the manner in which the data is captured, and/or other aspects of the environment. This metadata can include a point of view or direction of the capture device (e.g., as determined by a compass or other directional component of the capture device) at the time data regarding the environment is recorded. This metadata can also include a geographic location of the capture device (and thus also of the environment) at the time data regarding the environment is recorded, such as a geographic location determined by a Global Navigation Satellite System (GNSS) or other positioning component of the capture device. This metadata can also include a date and/or time that the data regarding the environment is recorded. In situations in which capture device 102 records metadata at the same time as data regarding the environment is recorded by device 102 (or within a threshold amount of time of data regarding the environment being recorded by device 102), the metadata is also referred to as being associated with the recorded data.

In one more embodiments, recording a geographic location of capture device 102 is performed only after receiving user consent to do so. This user consent can be an opt-in consent, where the user takes an affirmative action to request that the geographic location be recorded. Alternatively, this user consent can be an opt-out consent, where the user takes an affirmative action to request that the geographic location not be recorded. If the user does not choose to opt out of this geographic location recording, then it is an implied consent by the user that the geographic location be recorded. A privacy statement can also be displayed to the user, explaining to the user how recorded geographic locations are kept confidential. Furthermore, it should be noted that the recording of geographic locations of the device need not, and typically does not, include any personal information identifying particular users. Thus, although geographic locations for a particular user may be recorded, no indication of that particular user is recorded.

In one or more embodiments, capture device 102 records metadata describing various aspects of the capture device, the manner in which the data is captured, and/or other aspects of the environment, but does not capture or record other data regarding the environment. For example, capture device 102 can record the point of view or direction of the capture device as well as the geographic location of the capture device (and optionally a date and/or time that the metadata is recorded), but does not record any still image, video, and/or audio of the environment. Thus, capture device 102 can simply record just a position (and optionally a point of view or direction, a date and/or time, and so forth) of the capture device, which can be used by the enhancing captured data techniques as discussed below.

Playback devices 104 are devices that play back captured data enhanced using the techniques discussed herein. Captured data can be enhanced by replacing an element or portion of the captured data with a link to a substitute element or portion. Captured data can also be enhanced by adding links to one or more additional elements. Replacing elements or portions with substitute elements or portions, and/or adding links to one or more additional elements, enables or allows enhanced content to be constructed based on the captured data. These techniques for enhancing the captured data are discussed in additional detail below.

Each playback device 104 can be a variety of different types of devices, such as a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth. Thus, playback devices 104 can range from full resource devices with substantial memory and processor resources (e.g., personal computers, game consoles) to low-resource devices with limited memory and/or processing resources (e.g., traditional set-top boxes, televisions). Different playback devices 104 can be the same and/or different types of devices.

Capture devices 102 provide captured data and recorded metadata to one or more playback devices 104. Alternatively, captured data can be played back on the capture device, in which case a capture device 102 is also a playback device 104. Capture devices 102 can provide captured data and recorded metadata to playback devices in various manners, such as via network 108, via another link or connection (e.g., a wired or wireless connection, such as a Universal Serial Bus (USB) or Wireless USB connection), via a removable memory device (e.g., a flash memory device removed from a capture device 102 and inserted into a playback device 104) or other storage device, and so forth.

Crowd sourcing data service 106 maintains data used to enhance captured data. In one or more embodiments, data captured by capture devices 102 is provided to crowd sourcing data service 106. Additionally, or alternatively, data used to enhance captured data can be provided to service 106 from other sources. For example, data collections or libraries can be provided to service 106 from various sources. Service 106 is referred to as being a crowd sourcing service due to service 106 relying on data received from multiple sources to enhance captured data, rather than data from a single source.

Crowd sourcing service 106 is implemented using one or more of a variety of different types of devices. For example, service 106 can be implemented using any of a variety of types of devices as discussed above with respect to playback device 104. Service 106 can be implemented using one or more of the same and/or different types of devices.

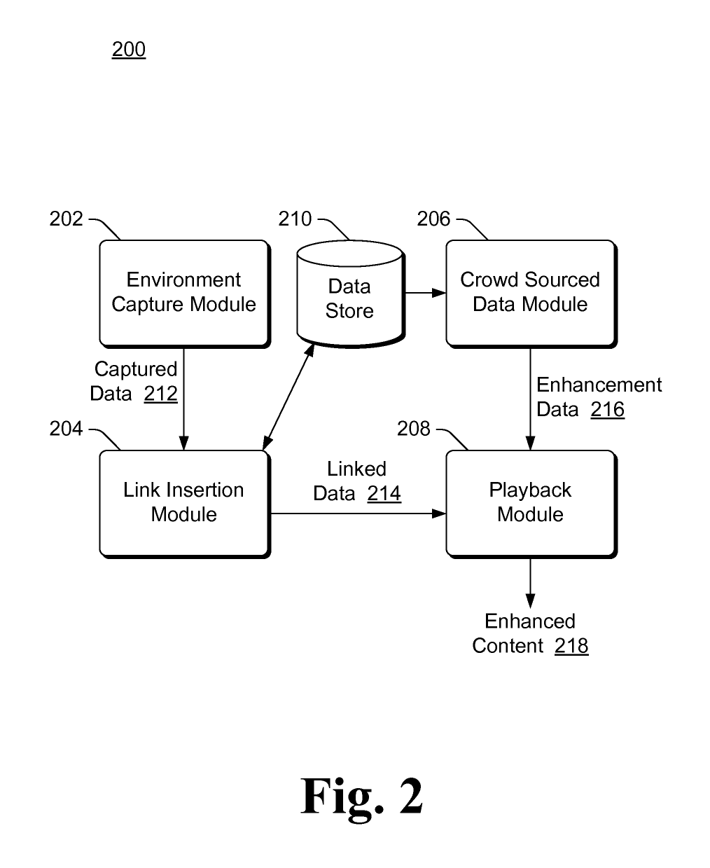

FIG. 2 illustrates an example data enhancement system 200 in accordance with one or more embodiments. System 200 includes an environment capture module 202, a link insertion module 204, a crowd sourced data module 206, and a playback module 208. Although specific modules are illustrated in FIG. 2, it should be noted that additional modules can be included in data enhancement system 200. Additionally, it should be noted that the functionality of multiple modules illustrated in data enhancement system 200 can be combined into a single module, and/or the functionality of one or more modules illustrated in data enhancement system 200 can be separated into multiple modules.

Modules 202-208 can be implemented by one or more devices. In one or more embodiments, modules 202-208 are each implemented by a different device. Alternatively, two or more of modules 202-208 can be implemented, at least in part, in the same device.

Environment capture module 202 is included in a capture device, such as a capture device 102 of FIG. 1, and captures data regarding an environment. The captured data 212, which can be various types of data and/or metadata regarding the environment can be captured as discussed above, is provided to link insertion module 204. Link insertion module 204 can be included in the same device as environment capture module 202, or alternatively a different device. Capture module 202 can provide captured data 212 to link insertion module 204 in various manners, such as including captured data 212 as a parameter when invoking an interface of module 204, storing captured data 212 in a location accessible to module 204, emailing or using other messaging protocols to communicate captured data 212 to module 204, and so forth.

Link insertion module 204 identifies elements of captured data 212 that can be replaced by elements from other data stored in data store 210. For an element of captured data 212 that module 204 identifies can be replaced by an element from other data (also referred to as a replaceable element), link insertion module 204 removes from captured data 212 the element that can be replaced, and adds (as associated with captured data 212) a link to the substitute element that is replacing that identified element. Different types of elements can be identified based on the type of data that is captured, such as photographic elements being identified if captured data 212 includes photographic or image data, audio elements being identified if captured data 212 includes audio data, and so forth.

Data store 210 maintains data used to enhance captured data, and can be implemented by crowd sourcing data service 106 of FIG. 1. The data included in data store 210 can be obtained from various sources, such as various capture devices 102 of FIG. 1, other data collections or libraries, and so forth.

Link insertion module 204 determines elements of captured data 212 that can be replaced by elements from other data by identifying elements (also referred to as parts) of the captured data that are the same or similar to data in data store 210. These elements can be identified using any of a variety of different publicly available and/or proprietary techniques for performing pattern matching and/or object matching. Objects or patterns in captured data 212 are identified using such techniques, and other data in data store 210 including the same or similar objects or patterns are identified. For example, if captured data 212 is a photograph, a building or landmark in the photograph is identified by module 204, and one or more other photographs in data store 210 that include the same building or landmark are also identified.

The pattern matching and/or object matching can take into account various factors from recorded data included in captured data 212, such as line and vertex locations in images, colors in images, sound patterns in audio, and so forth. The pattern matching and/or object matching can also take into account various factors from metadata included in captured data 212. For example, these factors from the metadata can include the geographic location of the device that captured the data, a point of view or direction of the device at the time the device captured the data, a date and/or time that the data was captured, and so forth.

For an element of captured data 212 that link insertion module 204 identifies can be replaced by an element from other data, link insertion module 204 removes from captured data 212 the identified element that can be replaced. This replaceable element can be removed from captured data 212 in different manners. In one or more embodiments, the data for the identified element is replaced with some other data (that typically can be compressed with a high compression ratio), such as a series of all “0” bit values or all “1” bit values. For example, if an element of a photograph (captured data 212) is removed, in the data for the photograph the data for the pixels included in that element can be replaced with the value “0” or “1”. In other embodiments, a table or other record identifying the removed element and its corresponding position in the data can be maintained, and the data for the identified element is simply deleted. For example, if an element of a photograph (captured data 212) is removed, a table or other record identifying which pixels in the photograph correspond to the element can be maintained, and in the data for the photograph the data for the pixels corresponding to the element can simply be deleted.

For each element of captured data 212 that link insertion module 204 removes, link insertion module 204 adds as associated with captured data 212 a link to the substitute element that is replacing that identified element. The link to the substitute element includes various information identifying where the substitute element is stored and/or how the substitute element can be retrieved, allowing the substitute element to be subsequently retrieved as discussed in more detail below.

In one or more embodiments, the substitute element is stored as its own individual data (e.g., its own file), and the link indicates where that individual data is stored in data store 210. The indication of where the individual data is stored can take different forms, such as a file pathname, a uniform resource indicator (URI), a location in a database, and so forth. The individual data can be generated in different manners, such as by another device or service, by link insertion module 204 (e.g., in response to identifying an element that can be replaced by a substitute element, module 204 can save that substitute element as a separate file).

In other embodiments, the substitute element is stored as part of other data (e.g., included as part of a file that stores other data), and the link indicates both where that other data is stored in data store 210 and where the substitute element is in the other data. The indication of where the other data is stored can take different forms, such as a file pathname, a URI, a location in a database, and so forth. The indication of where the substitute element is in the other data can take different forms, such as a particular data range, data associated with particular pixels, and so forth.

An indication is also recorded of where the replaceable element is located in captured data 212. The indication of where the replaceable element is in captured data 212 can take different forms, such as a particular data range, data associated with particular pixels, and so forth. Maintaining this indication of where the replaceable element is located in captured data 212 allows the substitute element to be added when generating enhanced content, as discussed in more detail below. The indication of where the replaceable element is in captured data 212 can be stored in different manners, such as stored as part of the link to the substitute element, stored in additional data associated with captured data 212, and so forth.

It should be noted that the pattern matching and/or object matching techniques used to identify elements of captured data 212 that can be replaced by substitute elements can select substitute elements that are similar to the identified elements of captured data 212. A substitute element that is similar to an identified element refers to an element that is not identical to the identified element, but has less than a threshold difference from the identified element. This threshold difference can be determined in different manners, such as having at least a threshold portion that is identical (e.g., at least a threshold number of pixels in photographs are the same values), having at least a threshold portion that is within a threshold amount of the identified element (e.g., at least a threshold number of pixels in photographs are within a threshold amount of one another), having generated scores that are within a threshold value of one another, and so forth.

In one or more embodiments, in situations in which the replaceable element and the substitute element are not identical, link insertion module 204 also records change data indicating the difference between the replaceable element and the substitute element. This change data can be recorded in different manners. For example, if captured data 212 is a photograph, then the change data can be the differences in values of corresponding pixels of the replaceable element and the substitute element. This change data can be stored in different manners, such as stored as part of the link to the substitute element, stored in additional data associated with the captured data 212, and so forth.

Alternatively, in situations in which the replaceable element and the substitute element are not identical, link insertion module 204 records no change data regarding the differences between the replaceable and substitute elements. Thus, link insertion module 204 can replace elements of an image with other views of that element (e.g., a view in which graffiti on a landmark is removed, a view in which people standing in front of a landmark are removed, etc.). A user interface can optionally be presented by link insertion module 204, allowing module 204 to receive user inputs identifying which of multiple possible views of an element are to be used as substitute elements for a replaceable element.

Link insertion module 204 provides linked data 214 to playback module 208. The linked data 214 is captured data 212 with the replaceable elements having been removed. In one or more embodiments, linked data 214 also includes (e.g., as associated metadata) the link to the substitute element that replaces the replaceable element and optionally also includes other additional data associated with the captured data 212. Thus, in such embodiments, linked data 214 includes the captured data 212 (less the removed elements) as well as links to the substitute elements (and optionally other additional data associated with the captured data 212).

Alternatively, rather than including the links to the substitute elements and/or other additional data associated with the captured data 212 in linked data 214, the association between linked data 214 and the link and/or other additional data associated with the captured data can be maintained in other manners. In one or more embodiments, the link and/or other additional data associated with the captured data 212 is maintained in a table or other record accessible to playback module 208. The link and/or other additional data associated with the captured data 212 can be identified as associated with captured data 212 in different manners, such as based on an identifier of captured data 212 (e.g., assigned by the capture device, generated based on captured data 212 itself (e.g., a hash value generated based on captured data 212), etc.). The link and/or other additional data associated with the captured data 212 can be stored in data store 210 or alternatively as part of another service or module, and accessed to generate enhanced content as discussed in more detail below.

It should be noted that link insertion module 204 can identify multiple elements in captured data 212 that can be replaced with different substitute elements. In such situations, for each of the multiple identified elements, module 204 removes the identified element from captured data 212 and adds a link to the substitute element that is replacing that identified element.

It should also be noted that the substitute element that is linked to can have a different resolution than the element that is replaced. For example, if captured data 212 is a photograph having a particular resolution, the substitute element can be included in a photograph having a higher resolution (e.g., more pixels per square inch). Thus, the substitute element can have additional detail that was not available in the identified element that was replaced. This additional detail can allow, for example, a user to zoom in on the substitute element when subsequently viewing the enhanced content and see details (e.g., text, people, artwork, etc.) that is not available in the identified element that was replaced.

Link insertion module 204 can also add to linked data 214 links to one or more additional elements. In one or more embodiments, module 204 adds links to one or more additional elements in addition to removing replaceable elements and adding links to substitute elements. In other embodiments, module 204 adds links to one or more additional elements rather than removing replaceable elements and adding links to substitute elements. Thus, in some embodiments, system 200 does not replace elements of captured data with substitute elements.

The links to one or more additional elements can be links to data in data store 210, and these links can identify where the additional elements are stored and/or how the additional elements can be retrieved in various manners, analogous to the links to substitute elements as discussed above. These links to one or more additional elements can be included as metadata associated with linked data 214, or otherwise associated with linked data 214, analogous to the links to substitute elements as discussed above.

The links to one or more additional elements enhance captured data 212 by adding data of various types to the captured data. The one or more additional elements can be the same type of data as captured data 212 and/or different types of data than captured data 212.

In one or more embodiments, the one or more additional elements include elements of the same type of data as captured data 212. For example, if captured data 212 is an image (a photograph), then the one or more additional elements include image data. Link insertion module 204 can determine the additional elements to include in various manners. In one or more embodiments, module 204 uses various pattern matching and/or object matching techniques to identify elements of captured data 212 (and/or linked to substitute elements associated with captured data 212) that are the same or similar to data in data store 210. This identification of elements that are the same or similar to data in data store 210 can be performed in the same manner as identifying elements of captured data that can be replaced by elements from other data as discussed above. As the additional elements are identified based on elements of captured data and/or linked to substitute elements associated with captured data 212, these additional elements are also referred to as being associated with the elements of the captured data and/or substitute elements.

The additional elements of the same type can be elements that include additional data or detail than the identified elements. For example, if captured data 212 is a photograph including a particular landmark as an identified element, then the additional elements can be photographs that provide additional detail regarding that same landmark. Link insertion module 204 can determine additional elements that include additional data or detail than an identified element in different manners. In one or more embodiments, module 204 determines that an additional element included in data captured at a higher resolution (e.g., more pixels per square inch for image data, a higher sampling frequency for audio data, etc.) than the identified element includes additional data or detail than the identified element. In other embodiments, module 204 determines an element resolution for both the identified element and an additional element. The resolution of an element refers to how much data or detail is included in the element (e.g., how many pixels, a number of bytes of data, etc.). Module 204 determines that an additional element includes additional data or detail than an identified element if the additional element has a higher element resolution than the additional element.

It should be noted that link insertion module 204 can determine that multiple additional elements have additional data or detail than the same identified element. In such situations, module 204 can include in linked data 214 a link to one of the multiple additional elements, or links to multiple ones (e.g., each one) of the multiple additional elements.

Link insertion module 204 can additionally, or alternatively, determine the one or more additional elements of the same type of data as captured data 212 to include in other manners. In one or more embodiments, link insertion module 204 determines the one or more additional elements to include in linked data 214 based on metadata of captured data 212. This metadata can include various information, such as geographic location of the capture device, point of view or direction of the capture device, and date and/or time the data is captured as discussed above. The data included in data store 210 also includes associated metadata, which can include the same information as the metadata associated with captured data 212. For example, data included in data store 210 can have associated metadata identifying a geographic location of a device that captured the data at the time the data was captured, a point of view or direction of a device that captured the data at the time the data was captured, date and/or time the data was captured, and so forth.

Link insertion module 204 identifies data in data store 210 having associated metadata that matches the metadata of captured data 212. Metadata matches if the information in the metadata is the same or within a threshold amount of one another. For example, if the metadata of captured data 212 includes a geographic location of the capture device, and metadata associated with data in data store 210 includes a geographic location, then the two metadata match if the geographic locations in the two metadata are the same or within a threshold distance of one another (e.g., 10 meters, 50 meters, etc.). By way of further example, if the metadata of captured data 212 also includes a direction of the capture device, and metadata associated with data in data store 210 includes a direction, then the two metadata match if the geographic locations in the two metadata are the same or within a threshold distance of one another and the directions are the same or within a threshold amount of one another (e.g., 3 degrees, 10 degrees, etc.).

Thus, link insertion module 204 can identify additional elements in data store 210 that enhance captured data 212 even though the additional elements are not elements that are the same or similar to an element in captured data 212. These additional elements can, for example, expand the field of view of an image or video, expand the captured audio, and so forth. For example, if captured data 212 is an image captured at a particular geographic location, with the captured device pointed in a particular direction, and at a particular time of day, then the additional element can be additional parts of the environment not included in captured data 212 (e.g., people, buildings, scenery, etc. outside the field of view of the capture device when capturing the image) but that were captured from that same (or close) geographic location, captured by devices pointed in the same (or similar) direction, and at the same (or similar) time of day. Thus, even though captured data 212 did not include those additional parts of the environment, they can still be included in linked data 214.

In one or more embodiments, the one or more additional elements include elements of different types of data as captured data 212. For example, if captured data 212 is an image (a photograph), then the one or more additional elements can include audio data, video data, and so forth. These different types of data can be any of the types of data that can be captured by a capture device (e.g., a capture device 102 of FIG. 1), or alternatively other types of data. For example, the one or more additional elements can be a text type of data (e.g., an encyclopedia entry or other written description), a drawing type of data, and so forth. The one or more additional elements can also include types of data other than those supported by the capture device. For example, if captured data 212 is captured by a device that does not record audio data, the one or more additional elements can include audio data.

Link insertion module 204 can determine the additional elements to include in linked data 214 in various manners. In one or more embodiments, link insertion module 204 determines additional elements of different data types to include in linked data 214 based on metadata associated with captured data 212 and metadata associated with data in data store 210. Link insertion module 204 identifies data in data store 210 having associated metadata that matches the metadata associated with captured data 212, analogous to the discussion above regarding determining additional elements of the same data type as captured data 212, although the additional elements are a different type of data than captured data 212.

Thus, link insertion module 204 can identify additional elements in data store 210 that enhance captured data 212 by providing types of data that are not included in captured data 212. For example, if captured data 212 is an image captured at a particular geographic location and at a particular time on a particular day, then the additional element can be additional types of data (e.g., audio data) for that environment not included in captured data 212 but that were captured from that same (or close) geographic location at the same (or similar) time on the same day. Thus, even though captured data 212 did not include those additional types of data, they can still be included in linked data 214.

Link insertion module 204 can also determine additional elements of different data types to include in linked data 214 in other manners in addition to or in place of using metadata of captured data 212. In one or more embodiments, link insertion module 204 determines additional elements of different data types to include in linked data 214 based on captured data 212 (or linked to substitute elements associated with captured data 212). For example, module 204 can use various pattern matching and/or object matching techniques to identify particular elements of captured data 212 (or a linked to substitute element), such as particular landmarks, particular individuals, and so forth. These techniques can also be used to identify various general environment types, such as concerts, sporting events, and so forth. The identified elements or general environment types for data in data store 210 are also identified, such as based on the data itself or based on an indication of identified elements or general environment types included in metadata associated with data in data store 210. As the additional elements are identified based on elements of captured data and/or linked to substitute elements associated with captured data 212, these additional elements are also referred to as being associated with the elements of the captured data and/or substitute elements.

These various pattern matching and/or object matching techniques can be used to identify particular elements of data in data store 210 (based on the data in data store 210 itself or metadata associated with the data in data store 210), and link insertion module 204 can identify data in data store 210 including the same particular elements. For example, module 204 can determine a particular environment type for captured data 212 (e.g., image data of a sporting event), and identify as additional elements other types of data in data store 210 having that same environment type (e.g., audio data of a sporting event). By way of another example, module 204 can determine a particular landmark for captured data 212 (e.g., image and/or video data), and identify as additional elements other types of data in data store 210 (e.g., a text description) having that same particular landmark.

It should be noted that the additional elements determined by link insertion module 204 can be portions of other data or other data in its entirety. For example, captured data 212 can be images or video, and the additional elements can be portions of other images, video, and/or audio, or alternatively can be other images, video and/or audio in their entirety. The additional elements can be determined by module 204 in different manners as discussed above, based on metadata associated with captured data 212, captured data 212 itself, and/or substitute elements. For example, module 204 can identify as the additional data one or more images that precede the time captured data 212 was captured by a threshold amount of time (e.g., fifteen seconds).

It should also be noted that environment capture module 202 may capture metadata describing various aspects of the capture device (e.g., geographic location of the device, direction or point of view of the device, etc.), but not record any other data regarding the environment (e.g., capture no images, capture no audio, capture no video, and so forth). Capture module 202 can thus be included in a device that has no environment sensors for sensing characteristics of the environment (e.g., no sensors to record images or audio in the environment), or included in a device that records metadata without recording data regarding the environment with environment sensors for sensing characteristics of the environment. However, based on the metadata, one or more additional elements can be determined by link insertion module 204, thereby adding in images, audio, video, and so forth to linked data 214. Thus, a capture device may include no image capture component, no audio capture component, and so forth, but simply record metadata describing aspects of the capture device (e.g., a geographic location and direction or point of view of the device). Image data and/or audio data in data store 210 can be identified as additional elements based on the metadata, as discussed above, and links to the additional elements can be added to linked data 214 by module 204.

Situations can arise in which captured data 212 includes multiple types of data (e.g., video data and audio data). Link insertion module 204 can optionally, by determining substitute elements and/or additional elements, replace one of those types of data. For example, one type of data (e.g., image data or video data) can be used to identify a particular environment type for captured data, and an additional element (e.g., audio data) having that same environment type can be identified. Module 204 can replace the corresponding type of data in captured data 212 with a link to the additional element. Thus, for example, the one type of data (e.g., image data or video data) in captured data 212 can remain in linked data 214, and the other type of data (e.g., audio data) in captured data 212 can be replaced with the link to the additional element.

Linked data 214 is provided to playback module 208. Link insertion module 204 can provide linked data 214 to playback module 208 in various manners, such as including data 214 as a parameter when invoking an interface of module 208, storing data 214 in a location accessible to module 208, emailing or using other messaging protocols to communicate data 214 to module 208, and so forth. Playback module 208 requests the elements that are linked to in data 214 from crowd sourced data module 206. Where the substitute (and/or additional elements) are stored and/or how the substitute (and/or additional elements) can be retrieved are identified by the links to the elements, as discussed above. Crowd sourced data module 206 obtains the linked to elements from data store 210, and provides the linked to elements to playback module 208 as enhancement data 216.

Playback module 208 receives enhancement data 216, and combines enhancement data 216 with linked data 214 to generate or construct enhanced content 218. Data 214 and 216 can be combined in different manners based on the type of elements included in enhancement data 216. For example, substitute elements can be added to data 214 (in the locations where the replaceable elements were in captured data 212). By way of another example, additional elements can be added to data 214. For example, a photograph can be enhanced to include additional parts not included in captured data 212, audio data can be added to image data, captured audio data can be replaced with other audio data, captured metadata with no other captured data regarding the environment can be enhanced to include audio and/or video data, and so forth. Playback module 208 can play back (e.g., display or otherwise present) enhanced content 218, or alternatively take other actions with enhanced content 218 (e.g., store enhanced content 218 on a particular storage device, transmit enhanced content 218 to another device or module, and so forth).

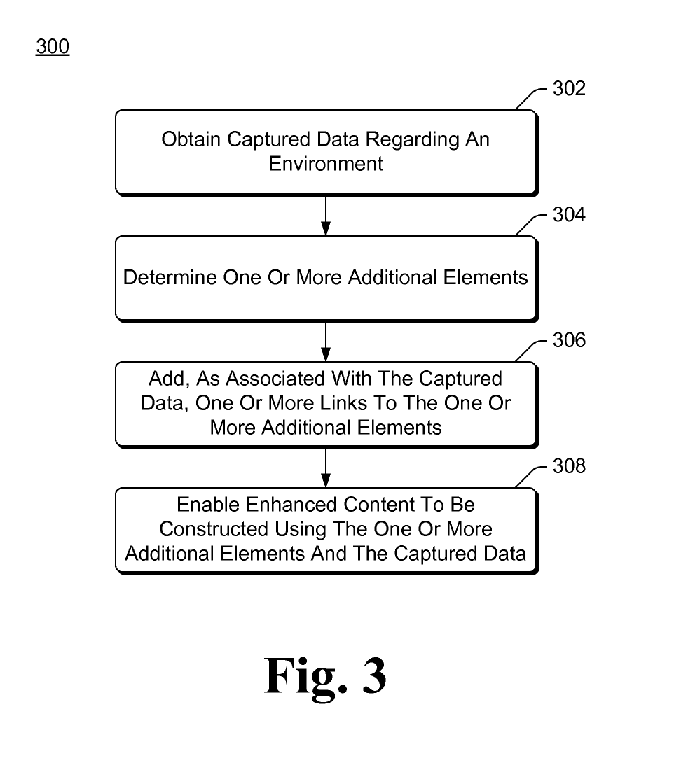

FIG. 3 is a flowchart illustrating an example process 300 for enhancing captured data in accordance with one or more embodiments. Process 300 is a method or scheme carried out by one or more modules, such as link insertion module 204 of FIG. 2, and can be implemented in software, firmware, hardware, or combinations thereof. Process 300 is shown as a set of acts and is not limited to the order shown for performing the operations of the various acts. Process 300 is an example process for enhancing captured data; additional discussions of enhancing captured data are included herein with reference to different figures.

In process 300, captured data regarding an environment is obtained (act 302). The captured data can be captured or provided to the one or more modules implementing process 300 in various manners, as discussed above.

One or more additional elements are determined (act 304). These one or more additional elements are determined based on the captured data as discussed above. User inputs to facilitate determining the one or more additional elements can optionally be received (e.g., user inputs indicating factors or techniques to use to identify additional elements, user inputs indicting types of data for the additional elements, user selection of one or more of multiple additional elements, and so forth).

One or more links to the one or more additional elements are added as associated with the captured data (act 306). These one or more links can be added in a variety of different manners, as discussed above.

Construction of enhanced content using the one or more additional elements and at least part of the captured data is enabled (act 308). The links to the one or more additional elements allow the enhanced content to be constructed. This construction includes combining the one or more additional elements and at least part of the captured data, as discussed above.

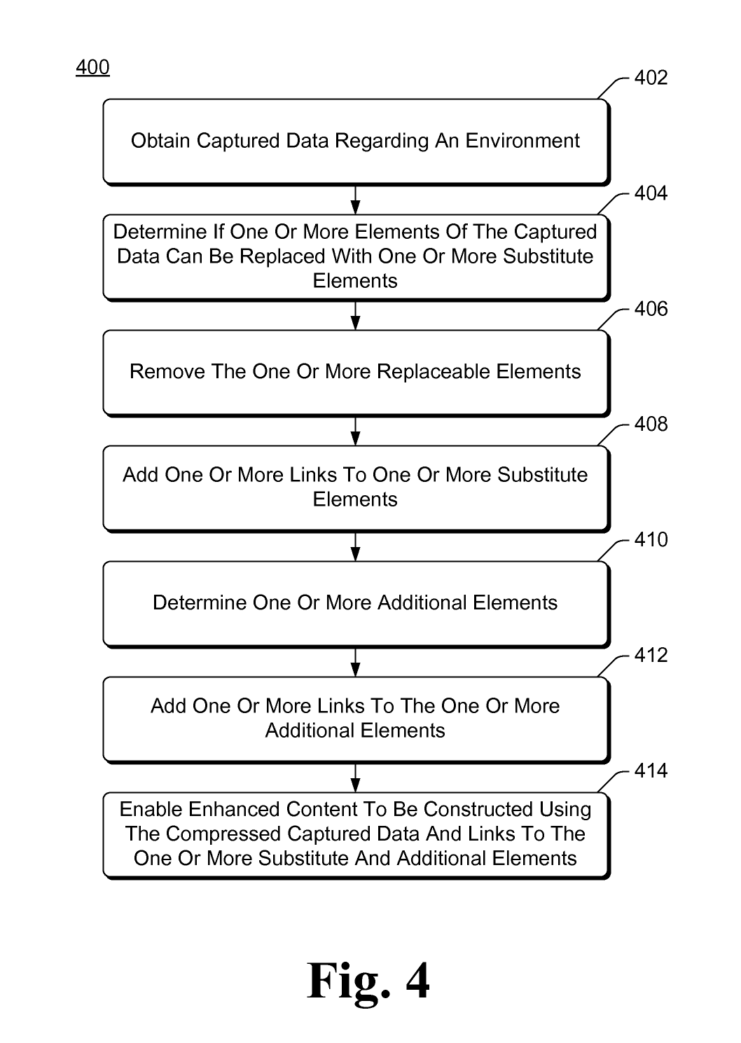

FIG. 4 is a flowchart illustrating another example process 400 for enhancing captured data in accordance with one or more embodiments. Process 400 is a method or scheme carried out by one or more modules, such as link insertion module 204 of FIG. 2, and can be implemented in software, firmware, hardware, or combinations thereof. Process 400 is shown as a set of acts and is not limited to the order shown for performing the operations of the various acts. Process 400 is an example process for enhancing captured data; additional discussions of enhancing captured data are included herein with reference to different figures.

In process 400, captured data regarding an environment is obtained (act 402). The captured data can be captured or provided to the one or more modules implementing process 400 in various manners, as discussed above.

A determination is made as to whether one or more elements of the captured data can be replaced with one or more substitute elements (act 404). This determination includes identifying the one or more replaceable elements and one or more substitute elements, as discussed above.

The one or more identified replaceable elements are removed from the captured data (act 406) to generate a compressed photograph. These replaceable elements can be removed in different manners, as discussed above.

One or more links to the one or more substitute elements are added (act 408). These one or more links are added as associated with the captured data, and can be added in a variety of different manners as discussed above. User inputs to facilitate determining the one or more substitute elements can optionally be received (e.g., user inputs indicating factors or techniques to use to identify substitute elements, user selection of one of multiple substitute elements, and so forth).

One or more additional elements are also determined (act 410). These one or more additional elements are determined based on the captured data (and/or substitute elements), and are associated with the replaceable element and/or substitute element as discussed above. User inputs to facilitate determining the one or more additional elements can optionally be received (e.g., user inputs indicating factors or techniques to use to identify additional elements, user inputs indicting types of data for the additional elements, user selection of one or more of multiple additional elements, and so forth).

One or more links to the one or more additional elements are added (act 412). These one or more links are associated with the captured data, and can be added in a variety of different manners as discussed above. The photograph is compressed due to, for example, the replaceable elements being removed from the photograph, and links for additional elements enhancing the photograph being linked to rather than the additional elements themselves being included in the photograph.

Construction of enhanced content using the compressed captured data and links to the one or more substitute and additional elements is enabled (act 414). The links to the one or more substitute elements and/or one or more additional elements allow the enhanced content to be constructed. This construction includes combining the one or more additional elements, substitute elements, and compressed captured data, as discussed above.

The enhancing captured data techniques discussed herein support various usage scenarios. For example, users can take pictures of various landmarks, works of art, landscapes, and so forth. Portions of their pictures can then be replaced with portions of other higher resolution pictures of the same landmark, work of art, landscape, and so forth, providing the user with a higher resolution picture than he or she took (and possibly higher resolution than his or her camera is capable of taking). The user is thus able to see additional detail, optionally being able to zoom in on portions of the picture to see people, writing, designs, and so forth that would not be visible in the picture that he or she took. Audio data can also be added to the picture, allowing the audio to be played back when the picture is subsequently displayed. Thus, the user can be presented with audio data corresponding to that landmark, work of art, landscape, and so forth, even though the user captured no such audio with his or her picture.

Although various discussions are included herein with reference to the captured data being photographs, it should be noted that the techniques discussed herein can be used with various other types of captured data as well, such as video data. Video data can be viewed as a sequence or array of frames, with each frame being treated as a photograph as discussed herein. The techniques discussed herein can be applied to multiple ones (e.g., each one) of the frames in the sequence or array. For a particular frame in the video, the one or more substitute elements can be elements from other photographs or videos, and/or elements from other frames of the same video. Thus, rather than compressing the video based on key frames and differences between the key frames and subsequent frames in the video, the video can be compressed by replacing elements in frames of the video with links to substitute elements in other frames of the video or elsewhere.

Various actions such as communicating, receiving, providing, recording, storing, generating, obtaining, and so forth performed by various modules are discussed herein. A particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

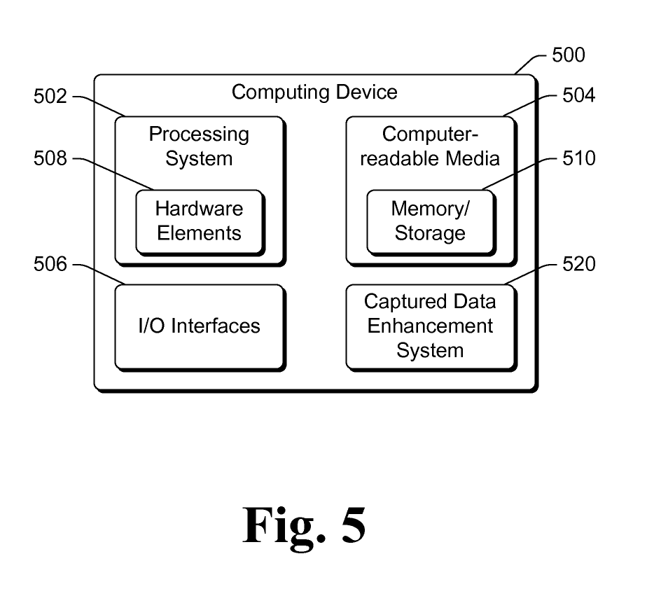

FIG. 5 illustrates an example computing device 500 that can be configured to implement the enhancing captured data in accordance with one or more embodiments. Computing device 500 can, for example, be a device 102 or 104 of FIG. 1, implement at least part of crowd sourcing data service 106 of FIG. 1, implement one or more modules 202-208 of FIG. 2, and so forth.

Computing device 500 as illustrated includes a processing system 502, one or more computer-readable media 504, and one or more I/O Interfaces 506 that are communicatively coupled to one another. Although not shown, computing device 500 can further include a system bus or other data and command transfer system that couples the various components to one another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

Processing system 502 is representative of functionality to perform one or more operations using hardware. Accordingly, processing system 502 is illustrated as including hardware elements 508 that can be configured as processors, functional blocks, and so forth. This can include implementation in hardware as an application specific integrated circuit or other logic device formed using one or more semiconductors. Hardware elements 508 are not limited by the materials from which they are formed or the processing mechanisms employed therein. For example, processors can be comprised of semiconductor(s) and/or transistors (e.g., electronic integrated circuits (ICs)). In such a context, processor-executable instructions can be electronically-executable instructions.

Computer-readable media 504 is illustrated as including memory/storage 510. Memory/storage 510 represents memory/storage capacity associated with one or more computer-readable media. Memory/storage 510 can include volatile media (such as random access memory (RAM)) and/or nonvolatile media (such as read only memory (ROM), Flash memory, optical disks, magnetic disks, and so forth). Memory/storage 510 can include fixed media (e.g., RAM, ROM, a fixed hard drive, and so on) as well as removable media (e.g., Flash memory, a removable hard drive, an optical disc, and so forth). Computer-readable media 504 can be configured in a variety of other ways as further described below.

Input/output interface(s) 506 are representative of functionality to allow a user to enter commands and information to computing device 500, and also allow information to be presented to the user and/or other components or devices using various input/output devices. Examples of input devices include a keyboard, a cursor control device (e.g., a mouse), a microphone (e.g., for voice or other audible inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, a tactile-response device, and so forth. Thus, computing device 500 can be configured in a variety of ways to support user interaction.

Computing device 500 also includes a captured data enhancement system 520. Captured data enhancement system 520 provides various functionality for enhancing captured data, including capturing data, inserting links, constructing enhanced content for playback, and/or providing crowd sourced data as discussed above. Captured data enhancement system 520 can be, for example, one or more modules 202-208 of FIG. 2.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques can be implemented on a variety of commercial computing platforms having a variety of processors.

An implementation of the described modules and techniques can be stored on or transmitted across some form of computer-readable media. The computer-readable media can include a variety of media that can be accessed by the computing device 500. By way of example, and not limitation, computer-readable media can include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 500, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 508 and computer-readable media 504 are representative of instructions, modules, programmable device logic and/or fixed device logic implemented in a hardware form that can be employed in some embodiments to implement at least some aspects of the techniques described herein. Hardware elements 508 can include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing can also be employed to implement various techniques and modules described herein. Accordingly, software, hardware, or program modules and other program modules can be implemented as one or more instructions and/or logic embodied on some form of computer-readable storage media and/or by one or more hardware elements 508. Computing device 500 can be configured to implement particular instructions and/or functions corresponding to the software and/or hardware modules. Accordingly, implementation of a module that is executable by the computing device 500 as software can be achieved at least partially in hardware, e.g., through use of computer-readable storage media and/or hardware elements 508 of the processing system. The instructions and/or functions can be executable/operable by one or more articles of manufacture (for example, one or more computing devices 500 and/or processing systems 502) to implement techniques, modules, and examples described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
obtaining captured data regarding an environment;
determining, based at least in part on the captured data, one or more additional elements;
adding, as associated with the captured data, one or more links to the one or more additional elements; and
enabling enhanced content to be constructed using the one or more additional elements and at least part of the captured data.

2. A method as recited in claim 1, further comprising:
determining one or more elements of the captured data that can be replaced by one or more substitute elements;
removing the one or more elements from the captured data; and
adding, as associated with the captured data, links to the one or more substitute elements.

3. A method as recited in claim 1, the captured data comprising an image.

4. A method as recited in claim 3, the one or more additional elements including audio data regarding the environment.

5. A method as recited in claim 1, the captured data comprising audio data.

6. A method as recited in claim 5, the one or more additional elements including image data regarding the environment.

7. A method as recited in claim 1, the captured data comprising metadata describing a geographic location of a device when the captured data was captured by the device, but the captured data including no images or audio captured at the geographic location.

8. A method as recited in claim 7, the one or more additional elements including an image captured at the geographic location by another device.

9. A method as recited in claim 1, the captured data comprising metadata describing a geographic location of a device when the captured data was captured by the device, and the determining comprising determining, based on the metadata, the one or more additional elements.

10. A method as recited in claim 9, the metadata further describing a point of view or direction of the device.

11. A method as recited in claim 1, further comprising:
identifying one or more elements in the captured data; and
the determining comprising determining, based on the identified one or more elements, the one or more additional elements.

12. A method as recited in claim 1, further comprising playing back the enhanced content.

13. A compression scheme for an enhanced photograph comprising:
determining if a photographic element of a photograph is replaceable including identifying the replaceable photographic element and one or more substitute photographic elements;
removing the replaceable photographic element to generate a compressed photograph;
adding one or more links to the one or more substitute photographic elements;
adding a link to an additional element associated with the replaceable photographic element or the substitute photographic element; and
enabling the enhanced photograph to be constructed using the compressed photograph and links to the one or more substitute photographic elements and the additional element.

14. The compression scheme of claim 13, the determining comprising:
identifying the replaceable photographic element; and
determining that the replaceable photographic element is replaceable in response to the replaceable photographic element being the same as or having less than a threshold difference from a substitute photographic element.

15. The compression scheme of claim 13, the adding one or more links to the one or more substitute photographic elements further comprising storing, for each replaceable element, change data indicating a difference between the replaceable photographic element and the substitute photographic element.

16. The compression scheme of claim 13, the substitute photographic element comprising a higher resolution than the replaceable photographic element.

17. The compression scheme of claim 13, the additional element expanding the field of view of the photograph.

18. The compression scheme of claim 13, the additional element comprising a different type of data than image data.

19. The compression scheme of claim 18, the different type of data comprising audio data or text data.

20. One or more computer storage media having stored thereon multiple instructions that, when executed by one or more processors of a device, cause the one or more processors to:
determine if a photographic element of a photograph is replaceable including identifying the replaceable photographic element and one or more substitute photographic elements;
remove, from the photograph, the replaceable photographic element to generate a compressed photograph;
add, as associated with the photograph, one or more links to the one or more substitute photographic elements;
determine, based on metadata associated with the photograph, an additional element, the metadata describing a geographic location of a capture device when the photograph was captured by the capture device;
add, as associated with the photograph, a link to the additional element, the additional element comprising audio data; and
enable the photograph to be constructed using the compressed photograph and links to the one or more substitute photographic elements and the additional element.
